(19) United States
(12) Patent Application Publication
(10) Pub. No.: US 2014/0278723 A1
(43) Pub. Date: Sep. 18, 2014

(54) METHODS AND SYSTEMS FOR PREDICTING WORKFLOW PREFERENCES

(71) Applicant: XEROX CORPORATION, Norwalk, CT (US)

(72) Inventors: Hua Liu, Fairport, NY (US); Tong Sun, Penfield, NY (US)

(73) Assignee: XEROX CORPORATION, Norwalk, CT (US)

(21) Appl. No.: 13/799,160

(22) Filed: Mar. 13, 2013

(51) Int. Cl. G06Q 10/06

(52) U.S. Cl. CPC G06Q 10/0633
USPC 705/7.27

(57) ABSTRACT

A method of evaluating a workflow may include identifying a plurality of workflows. Each workflow may be associated with one or more users, and each workflow may represent a flow of data between a plurality of services via one or more execution paths. The method may include clustering, by a computing device, the execution paths associated with the plurality of workflows into a plurality of groups. The clustering may be based on the associated services. The method may include creating, by the computing device, a feature tree for each group, clustering, by the computing device, at least a portion of the users into a plurality of interest groups based on at least one of the feature trees, and for at least one of the interest groups, predicting, by the computing device, one or more preferences for one or more users in the interest group.

### BACKGROUND

Service providers, such as backend-as-a-service and software-as-a-service providers, typically offer services performed in a logical sequence to its users. For example, a user may submit a business process that includes service types to a cloud service provider. A service cloud broker selects concrete services for each service type to instantiate the business process into a workflow. However, the selected services may not align with a user's preferences, and it is often difficult for users to articulate their preferences.

### SUMMARY

This disclosure is not limited to the particular systems, methodologies or protocols described, as these may vary. The terminology used in this description is for the purpose of describing the particular versions or embodiments only, and is not intended to limit the scope.

As used in this document, the singular forms “a,” “an,” and “the” include plural reference unless the context clearly dictates otherwise. Unless defined otherwise, all technical and scientific terms used herein have the same meanings as commonly understood by one of ordinary skill in the art. All publications mentioned in this document are incorporated by reference. All sizes recited in this document are by way of example only, and the invention is not limited to structures having the specific sizes or dimension recited below. Nothing in this document is to be construed as an admission that the embodiments described in this document are not entitled to antedate such disclosure by virtue of prior invention. As used herein, the term “comprising” means “including, but not limited to.”

In an embodiment, a method of evaluating a workflow may include identifying a plurality of workflows. Each workflow may be associated with one or more users, and each workflow may represent a flow of data between a plurality of services via one or more execution paths. The method may include clustering, by a computing device, the execution paths associated with the plurality of workflows into a plurality of groups. The clustering may be based on the associated services. The method may include creating, by the computing device, a feature tree for each group, clustering, by the computing device, at least a portion of the users into a plurality of interest groups based on at least one of the feature trees, and for at least one of the interest groups, predicting, by the computing device, one or more preferences for one or more users in the interest group.

In an embodiment, a system of evaluating a workflow may include a computing device and a computer-readable storage medium in communication with the computing device. The computer-readable storage medium may include one or more programming instructions that, when executed, cause the computing device to identify a plurality of workflows. Each workflow may be associated with one or more users, and each workflow may represent a flow of data between a plurality of services via one or more execution paths. The computer-readable storage medium may include one or more programming instructions that, when executed, cause the computing device to cluster the execution paths associated with the plurality of workflows into a plurality of groups, where the clustering may be based on the associated services, create a feature tree for each group, cluster at least a portion of the users into a plurality of interest groups based on at least one of the feature trees, and for at least one of the interest groups, predict one or more preferences for one or more users in the interest group.

### BRIEF DESCRIPTION OF THE DRAWINGS

FIGS. 1 and 2 illustrate example workflows according to various embodiments.

FIG. 3 illustrates a flow chart of an example method of evaluating a workflow according to an embodiment.

FIG. 4 illustrates a block diagram of hardware that may be used to contain or implement program instructions according to an embodiment.

### DETAILED DESCRIPTION

The following terms shall have, for purposes of this application, the respective meanings set forth below:

A “computing device” refers to a device that includes a processor and tangible, computer-readable memory. The memory may contain programming instructions that, when executed by the processor, cause the computing device to perform one or more operations according to the programming instructions. Examples of computing devices include personal computers, servers, mainframes, gaming systems, televisions, and portable electronic devices such as smartphones, personal digital assistants, cameras, tablet computers, laptop computers, media players and the like.

An “execution path” refers to at least a portion of a workflow.

A “feature tree” refers to a representation of one or more sub-execution paths in one or more workflows. Each node in a feature tree may represent a sub-execution path. A feature tree may include one or more parent nodes and one or more child nodes. A parent node may represent a super-sequence of its child node(s), and a child node may represent a sub-sequence of its parent node.

A “workflow” refers to a plurality of services that are performable in a sequence. For example, in a print production environment, a workflow may include a sequence of services to be performed to process a print job. Such services may include, for example, printing, binding, collating, cutting and/or the like.

In an embodiment, a user may request that a service provider perform a business process on behalf of the user. A business process may include one or more workflows. For example, a business process may require performing four distinct services in a certain order. Additional and/or alternate numbers of services may be used within the scope of this disclosure.

FIG. 1 shows an example of a workflow according to an embodiment. As illustrated by FIG. 1, the workflow 100 includes five services: s1 102, s2 104, s3 106, s4 108 and s5 110.

In an embodiment, a workflow may be associated with one or more different execution paths. An execution path may be attributable to options amongst services to be provided, the presence of one or more loops and/or the like. Table 1 illustrates example execution paths associated with FIG. 1 according to an embodiment. As illustrated by Table 1, a first execution path may include the services {s1, s2, s4, s5} while a second execution path may include the services {s1, s3, s4, s5}.

TABLE 1

| Execution path | Rating |
|---|---|
| s1, s2, s4, s5 | 1 |
| s1, s3, s4, s5 | −1 |

FIG. 2 illustrates another example of a workflow, and Table 2 illustrates example execution paths associated with FIG. 2 according to an embodiment. As shown by FIG. 2, a workflow may include one or more loops. As such, the number of execution paths may be unlimited.

TABLE 2

| Execution path | Rating |
|---|---|
| s1, s2, s4, s5 | 1 |
| s1, s2, s4, s1, s2, s4, s5 | 1 |
| s1, s2, s4, s1, s2, s4, s1, s2, s4, s5 | −1 |

In an embodiment, an execution path may be associated with a rating. A rating may represent a user's preference for an execution path. In an embodiment, a rating may be binary value as illustrated by Table 1. For example, “1” may represent a good rating, while “−1” may represent a poor rating. Additional and/or alternate binary and/or non-binary ratings may be used within the scope of this disclosure.

In an embodiment, a rating may be assigned to an execution path by a user. For example, after a business process requested by a user is completed, a user may be asked to rate the execution path used to complete the business process. The rating may be based on timeliness of completion, thoroughness, throughput, availability, cost, quality and/or the like.

FIG. 3 illustrates a flow chart of an example method of evaluating a workflow according to an embodiment. As illustrated by FIG. 3, information associated with workflows performed on behalf of one or more users may be identified 300. In an embodiment, information may include historical data associated with one or more workflows previously performed for a user. For example, information may include one or more ratings associated with one or more execution paths of previously performed workflows.

In an embodiment, if an execution path, Eᵢ, is rated good, then every sub-sequence of the execution path, E_{i,sub}, may have a good rating. In an embodiment, if an execution path, Eᵢ, is rated bad, then every super-sequence of the execution path, E_{i,super}, may have a bad rating. In an embodiment, if ratings associated with an execution path are contradicting, then the last rating may be used. For example, if a user rates Eᵢ as good but E_{i,sub} as bad, the most recent rating may be used. Similarly, if a user rates Eᵢ as bad but E_{i,super}, as good, the most recent rating may be used.

In an embodiment, information associated with workflows may be identified 300 by retrieving information from a list, database or other storage media. For example, information associated with historical workflows performed by one or more users may be stored in a database.

In an embodiment, execution paths in the identified information may be clustered 302 into one or more groups. Execution paths may be clustered according to any clustering algorithm, such as, for example, fuzzy C-means. Execution paths that share one or more common services may be clustered into the same group. Clustering execution paths may help extract services, which may be represented as shared common sub-execution paths.

In an embodiment, one or more feature trees may be created 304 based on the clustering. A feature tree may be a graphical representation of one or more workflows. A feature tree may include one or more nodes that each represents a sub-execution path.

In an embodiment, each execution path in a group may be identified. Each execution path may be compared to one or more other execution paths in the group to determine a greatest common denominator between the two execution paths. For example, a first execution path may be compared to a second execution path to determine a sub-execution path that includes one or more services that is the greatest common denominator. The second execution path may be compared to a third execution path to determine a sub-execution path that includes one or more services that is the greatest common denominator, and so on. In an embodiment, a determined greatest common denominator service may be inserted into a feature tree where each feature is a shared common sub-execution path. Each parent node in the feature tree may represent a super-sequence of a child node.

The following pseudo code illustrates an example method of extracting services and creating a feature tree according to an embodiment:

```
for every group (gᵢ) in the groups
    ₛᵢ = all execution paths,
    for every execution path (eᵢ where i is from 1 to the size of sᵢ) in sᵢ
        for j = i + 1 to sᵢ
            c = the greatest common denominator between eᵢ and eⱼ
            insert c into the feature tree where every parent node is a
            super-sequence of a child node
```

In an embodiment, a child node in a feature tree may represent a sub-sequence of its parent node(s). Similarly, a parent node may be a super-sequence of all of its child nodes. As such, inserting new nodes into a feature tree must be done in order to preserve this structure. The following pseudo code illustrates an example method of inserting one or more nodes into a feature tree according to an embodiment.

```
x = c
clean subsequence, supersequence and sharesequence queues
initialize supersequence with the root node
while (supersequence is not empty)
    n = dequeue supersequence
    linkFlag = true;
    if ( n has no child node )
        add x as the child node of n
        continue;
    for every child node s of n
        if s equals x
            increase the weight of s by 1
            break;
        else if s is a sub sequence of x
            add s to the subsequence queue
        else if s is a super sequence of x
            add s to the supersequence queue
            linkFlag = false;
        else if s shares a sub sequence with x
            add s to the sharesequence queue
        if ( linkFlag) add x as the child node of n
        if (subsequence queue is not null)
            for all the nodes in the subsequence, remove n from their
        father node list and add x to their father node list
        if (sharesequence is not null)
            for every node m in sharesequence
                breadth first search the sub tree of m, if a node is a sub
            sequence of x, add x to its father node list
```

In an embodiment, a feature tree may be created for every group. Each node may be a sub-execution path that is shared by at least two execution paths.

In an embodiment, each sub-execution path may have an associated weight. A weight may represent a sub-execution path's popularity. In an embodiment, popularity may indicate a relative number of execution paths that share a sub-execution path. For example, if five execution paths share a sub-execution path, then the weight associated with that sub-execution path may be ‘5’. Additional and/or alternate indications of popularity may be used within the scope of this disclosure.

In an embodiment, a feature tree may be pruned by deleting one or more sub-execution paths associated with weights that are less than a threshold value. A threshold value may be dynamically determined based on the distribution of weights associated with a service tree. In an embodiment, pruning a feature tree may help remove relatively unshared sub-execution paths, and therefore reduce the data space occupied by the feature tree.

In an embodiment, users may be clustered 306. For example, users who have rated execution paths may be clustered 306. Users may be clustered 306 based on the ratings they assigned to execution paths, workflows and/or the like. In an embodiment, a matrix of users and sub-execution paths may be used to cluster users. Each column of the matrix may represent a user, and each row of the matrix may represent a sub-execution path. Table 3 illustrates an example matrix according to an embodiment. As illustrated by Table 3, a value in the matrix, v_{i,j}, represents user j's rating of sub-execution path i. For example, User 1's rating of Sub-execution Path 3 is ‘−1’. As discussed above, ‘1’ may indicate a positive rating and ‘−1’ may indicate a negative rating. If a user did not use a workflow that includes a sub-execution path, or if a user has not rated a particular sub-execution path, the sub-execution path may be associated with a rating of ‘0’.

TABLE 3

| | User 1 | User 2 | User 3 | User 4 |
|---|---|---|---|---|
| Sub-Execution Path 1 | 1 | 0 | −1 | 1 |
| Sub-Execution Path 2 | 0 | −1 | 1 | 1 |
| Sub-Execution Path 3 | −1 | 1 | 0 | −1 |
| Sub-Execution Path 4 | 1 | 0 | 0 | 1 |

In an embodiment, one or more users may be clustered 306 into one or more interest groups. A similarity value may be determined for one or more pairs of groups. For example, a similarity value between group g, and gⱼ may be computed by the following:

sim(gᵢ,gⱼ)=Σₖ₌ᵢⁿsₖ, where
n is the number of sub-execution paths,
sₖ is computed as:

if g_{i,k}=g_{i,k}=1 or g_{i,k}=g_{i,k}=−1, then sₖ=1
otherwise, sₖ=0

In an embodiment, a difference value between one or more pairs of groups may be determined. For example, a difference value between group g, and gⱼ may be computed by the following:

diff(gᵢ,gᵢ)=Σₖ₌ᵢⁿdₖ, where
n is the number of sub-execution paths,
dₖ is computed as:

if g_{i,k}*g_{j,k}−1, then dₖ=1
otherwise, dₖ=0

In an embodiment, the two groups having the highest similarity scores may be merged into another group, gₘ. In an embodiment, if users in group m rate sub-execution path k as a ‘1’ or ‘0’, with at least one user rating sub-execution path k as a ‘=1’, then g_{m,k}=1. In an embodiment, if users in a group m rates sub-execution path k as ‘−1’ or ‘0’ with at least one user rating sub-execution path k as ‘−1’, then g_{m,k}=−1. Otherwise, g_{m,k} may equal ‘0’.

In an embodiment, merging of two groups may be stopped when a ratio of the similarity value of the two groups to the difference value of the two groups is less than a threshold value. For example, merging of two groups (gᵢ and gⱼ) may be stopped when:

$$\frac{sim ( {g}_{i} , {g}_{j} )}{diff ( {g}_{i} , {g}_{j} )} < threshold value$$

In an embodiment, one or more user preferences may be predicted 308 for gₘ. For example, execution paths and their ratings may be used to predict user preferences in terms of sub-execution paths. However, it is often difficult to understand sub-execution paths as fragments of execution paths. As such, one or more quality of service (QoS) attributes may be used to predict preferences at a higher level. QoS attributes may include service QoS attributes and/or link QoS attributes.

Service QoS attributes may refer to one or more performance metrics associated with a service. For example, metrics may include, without limitation, response time, cost, reliability, availability and/or the like.

Link QoS attributes may refer to the quality-of-service of the link between two services in a workflow. If a link exists between two services, then one service may provide data to the other service. The data may be transferred over a network from one service to another. Link QoS attributes may refer to one or more metrics associated with the transfer of data between two services. Example Link QoS attributes may include, without limitation, network speed, throughput, reliability, availability and/or the like.

In an embodiment, QoS attribute data may be accessed via a monitoring service or other type of service. For example, a monitoring service may track QoS attribute data for one or more services, and may provide this information in response to a request for such information.

In an embodiment, predicting 308 one or more preferences may involve identifying 310 an execution path having a good rating and identifying 312 an execution path having a poor rating for one or more users in an interest group. For illustrative purposes, s1s2 may be an execution path having a good rating and s1s3 may be an execution path having a poor rating. In an embodiment, the execution paths that are identified 310, 312 may be of the same length. For example, s1s2 and s1s3 both include two services and one link between services. As such, they are the same length.

In an embodiment, the execution paths that are identified 310, 312 may share one or more common services. In an embodiment, the identified execution paths may include the most number of common services amongst available execution paths. In an embodiment, the identified execution paths may include at least a threshold number of common services. For instance, the example execution paths above, s1s2 and s1s3, share 50% common services since both execution paths include s1.

In an embodiment, one or more QoS attribute values associated with the execution path having a good rating may be determined 314. In an embodiment, the way in which a QoS attribute value is determined may depend on the attribute. Example techniques for determining a QoS attribute value may include, without limitation, determining a linear sum, multiplication, determining a minimum value, determining a maximum value and/or the like.

For instance, an execution time associated with an execution path may be a linear sum of the execution times of each service in the execution path, and the time it takes to transmit data between services. For example, referring to execution path s1s2, s1 may execute for three minutes, transmission of data from s1 to s2 may take ten seconds, and s2 may execute for one minute. As such, the execution time of this execution path may be the linear sum of the execution and transmission times (i.e., four minutes and ten seconds).

As another example, an availability associated with an execution path may be determined through multiplication. For instance, using the example above, the availabilities associated with the execution path, s1s2, above may be 90% for s1, 80% for the link between s1 and s2, and 95% for s2. The availability for the execution path may be determined by multiplying the availabilities. For example, the availability for this execution path may be 68.4% (i.e., 90%*80%*85%).

In an embodiment, one or more QoS values associated with one or more execution paths having a bad rating may be determined 316. For example, s1s2 may be rated as good by a user, but another execution path, s1s3, may be rated as bad by a user. The execution time associated with s1s3 may be four minutes, and the availability associated with s1s3 may be 30%. Table 4 illustrates example QoS attribute values for these execution paths according to an embodiment.

TABLE 4

| | | S1 → | | | | | S1→ | | |
|---|---|---|---|---|---|---|---|---|---|
| S1s2 | S1 | s2 | S2 | Total | S1s3 | S1 | s3 | S3 | Total |
| Execution | 3 min | 10 sec | 1 min | 4 min | Execution | 3 min | 15 sec | 45 sec | 4 min |
| time | | | | 10 sec | time | | | | |
| Availability | 90% | 80% | 95% | 68.4% | Availability | 60% | 83% | 60% | 29.8% |

In an embodiment, one or more QoS attribute values may be evaluated 318. One or more attribute values of the execution path rated as good may be compared to a corresponding attribute value of the execution path rated as bad in an effort to predict user preferences. In an embodiment, a comparison of values may yield a probability that the attribute is responsible for the bad rating associated with one of the execution paths. In an embodiment, the probability may be based on the similarity or difference between compared values. For example, if two values are relatively similar or are within a certain value or percentage of one another, the probability that the attribute is responsible for the bad rating may be relatively small. However, if there is a great difference between two values, or if the difference between the two values exceeds a threshold amount, then the probability that the corresponding attribute is responsible for the bad rating may be relatively high.

For example, the execution time for s1s2 (4 minutes 10 seconds) may be compared to the execution time for s1s3 (4 minutes). In this situation, the execution times are relatively similar, so the probability that execution time is responsible for the bad rating of s1s3 is low.

However, comparing the availability of s1s2 (68.4%) to the availability of s1s3 (30%) shows a large difference between the values. As such, the probability that the availability QoS attribute is responsible for the bad rating associated with s1s3 may be relatively high.

In an embodiment, the QoS attributes having high probabilities of being responsible for a bad rating and/or the QoS attributes having high probabilities of being a user preference may be identified 320. In an embodiment, a QoS attribute may have a high probability of being responsible for a bad rating if it is associated with a probability that falls below a threshold value. In an embodiment, a QoS attribute may have a high probability of being a user preference if it is associated with a probability that equals or exceeds a threshold value. One or more user preference predictions may be made based on the identified QoS attribute. For example, referring to the above example, the system may predict that the user prefers availability for workflows.

For instance, the probability of availability being a user preference may 90%, the probability of response time being a user preference may be 60% and the probability of reliability being a user preference may be 10%. A threshold value may be 50%, meaning that a QoS attribute having a probability that falls below 50% may be identified as being responsible for a bad rating, and a QoS attribute having a probability equal to or exceeding 50% may be identified as a user-preferred QoS attribute. Three execution paths may exist. Path 1 may have high availability, medium response time and low reliability. Path 2 may have high availability, low response time, and high reliability. Path 3 may have low availability, medium response time, and high reliability. The system may recommend Path 1 followed by Path 2 because these paths have QoS attributes (i.e., availability and response time) that have high probabilities of being user preferences. The system may not recommend Path 3 because the associated QoS attribute that has the highest rating is reliability which is the QoS attribute that has the lowest probability of being a user preference. Additional and/or alternate ratings, probabilities and selections may be used within the scope of this disclosure.

In an embodiment, a profile associated with a user may be updated 322 to reflect the identified predictions. For example, an indication that a user prefers or does not prefer one or more QoS attributes may be added to the user's profile. For instance, using the above example, an indication that the user prefers availability may be added to a profile associated with the user.

In an embodiment, the system may provide 324 one or more subsequent workflow recommendations to a user. The subsequent workflow recommendations may be based on one or more user preferences from the user's profile. For instance, using the above example, the system may suggest to the user only workflows that have high availability.

FIG. 4 depicts a block diagram of hardware that may be used to contain or implement program instructions. A bus 400 serves as the main information highway interconnecting the other illustrated components of the hardware. CPU 405 is the central processing unit of the system, performing calculations and logic operations required to execute a program. CPU 405, alone or in conjunction with one or more of the other elements disclosed in FIG. 4, is an example of a production device, computing device or processor as such terms are used within this disclosure. Read only memory (ROM) 410 and random access memory (RAM) 415 constitute examples of non-transitory computer-readable storage media.

A controller 420 interfaces with one or more optional non-transitory computer-readable storage media 425 to the system bus 400. These storage media 425 may include, for example, an external or internal DVD drive, a CD ROM drive, a hard drive, flash memory, a USB drive or the like. As indicated previously, these various drives and controllers are optional devices.

Program instructions, software or interactive modules for providing the interface and performing any querying or analysis associated with one or more data sets may be stored in the ROM 410 and/or the RAM 415. Optionally, the program instructions may be stored on a tangible non-transitory computer-readable medium such as a compact disk, a digital disk, flash memory, a memory card, a USB drive, an optical disc storage medium, such as a Blu-ray™ disc, and/or other recording medium.

An optional display interface 430 may permit information from the bus 400 to be displayed on the display 435 in audio, visual, graphic or alphanumeric format. Communication with external devices, such as a printing device, may occur using various communication ports 440. A communication port 440 may be attached to a communications network, such as the Internet or an intranet.

The hardware may also include an interface 445 which allows for receipt of data from input devices such as a keyboard 450 or other input device 455 such as a mouse, a joystick, a touch screen, a remote control, a pointing device, a video input device and/or an audio input device.

It will be appreciated that various of the above-disclosed and other features and functions, or alternatives thereof, may be desirably combined into many other different systems or applications or combinations of systems and applications. Also that various presently unforeseen or unanticipated alternatives, modifications, variations or improvements therein may be subsequently made by those skilled in the art which are also intended to be encompassed by the following claims.

What is claimed is:

1. A method of evaluating a workflow, the method comprising:
identifying a plurality of workflows wherein each workflow is associated with one or more users, wherein each workflow represents a flow of data between a plurality of services via one or more execution paths;
clustering, by a computing device, the execution paths associated with the plurality of workflows into a plurality of groups, wherein the clustering is based on the associated services;
creating, by the computing device, a feature tree for each group;
clustering, by the computing device, at least a portion of the users into a plurality of interest groups based on at least one of the feature trees; and
for at least one of the interest groups, predicting, by the computing device, one or more preferences for one or more users in the interest group.

2. The method of claim 1, wherein identifying a plurality of workflows associated with one or more users comprises identifying a plurality of historical workflows that have been performed on behalf of one or more of the users.

3. The method of claim 1, wherein clustering the execution paths associated with the plurality of workflows into a plurality of groups comprises clustering the execution paths into a plurality of groups such that execution paths having one or more common services are clustered in a same group.

4. The method of claim 1, wherein creating a feature tree for each group comprises:
identifying a first execution path in the group;
identifying a sub-execution path that is a greatest common denominator between the first execution path and second execution path in the group; and
adding the identified sub-execution path to the feature tree.

5. The method of claim 1, wherein creating a feature tree comprises creating a feature tree that comprises at least one parent node and at least one child node, wherein each parent node and each child node is associated with the parent node represents a super sequence of each child node.

6. The method of claim 1, wherein each sub-execution path in the feature tree is associated with a popularity value, wherein each popularity value is indicative of a number of execution paths that include the associated sub-execution path.

7. The method of claim 6, further comprising:
identifying a service in the feature tree that is associated with a popularity value that is less than a threshold value; and
removing the identified sub-execution path from the feature tree.

8. The method of claim 1, wherein clustering the plurality of users into a plurality of interest groups comprises:
for each user, determining a rating that the user assigned to one or more sub-execution paths in the associated feature tree; and
clustering the users based on the ratings so that users who assigned similar ratings to sub-execution paths are included in the same interest group.

9. The method of claim 1, wherein predicting one or more preferences for one or more users in the interest group comprises:
identifying a first execution path that was rated highly by a user in the interest group;
identifying a second execution path that was rated poorly by the user in the interest group, wherein the first execution path and the second execution path share one or more common services and a common length;
identifying a plurality of quality of service attributes associated with the first execution path and the second execution path; and
for each identified quality of service attribute:
determining a first value that is associated with the first execution path,
determining a second value that is associated with the second execution path, and
using the first value and the second value to determine a probability that the quality of service attribute is responsible for the poor rating of the second execution path.

10. The method of claim 9, further comprising:
identifying one or more quality of service attributes having a probability that does not exceed a threshold value; and
updating profiles of the users in the interest group to reflect a preference for the identified quality of service attributes.

11. The method of claim 10, further comprising recommending one or more subsequent workflows to at least one of the users in the interest group such that the recommended workflows each reflect the preference.

12. A system of evaluating a workflow, the system comprising:
a computing device; and
a computer-readable storage medium in communication with the computing device, wherein the computer-readable storage medium comprises one or more programming instructions that, when executed, cause the computing device to:
identify a plurality of workflows wherein each workflow is associated with one or more users, wherein each workflow represents a flow of data between a plurality of services via one or more execution paths,
cluster the execution paths associated with the plurality of workflows into a plurality of groups, wherein the clustering is based on the associated services,
create a feature tree for each group,
cluster at least a portion of the users into a plurality of interest groups based on at least one of the feature trees, and
for at least one of the interest groups, predict one or more preferences for one or more users in the interest group.

13. The system of claim 12, wherein the one or more programming instructions that, when executed, cause the computing device to identify a plurality of workflows associated with one or more users comprise one or more programming instructions that, when executed, cause the computing device to identify a plurality of historical workflows that have been performed on behalf of one or more of the users.

14. The system of claim 12, wherein the one or more programming instructions that, when executed, cause the computing device to cluster the execution paths associated with the plurality of workflows into a plurality of groups comprise one or more programming instructions that, when executed, cause the computing device to cluster the execution paths into a plurality of groups such that execution paths having one or more common services are clustered in a same group.

15. The system of claim 12, wherein the one or more programming instructions that, when executed, cause the computing device to create a feature tree for each group comprise one or more programming instructions that, when executed, cause the computing device to:
identify a first execution path in the group;
identify a sub-execution path that is a greatest common denominator between the first execution path and second execution path in the group; and
add the identified sub-execution path to the feature tree.

16. The system of claim 12, wherein the one or more programming instructions that, when executed, cause the computing device to create a feature tree comprise one or more programming instructions that, when executed, cause the computing device to create a feature tree that comprises at least one parent node and at least one child node, wherein each parent node and each child node is associated with the parent node represents a super sequence of each child node.

17. The system of claim 12, wherein each sub-execution path in the feature tree is associated with a popularity value, wherein each popularity value is indicative of a number of execution paths that include the associated sub-execution path.

18. The system of claim 17, wherein the computer-readable storage medium further comprises one or more programming instructions that, when executed, cause the computing device to:
identify a sub-execution path in the feature tree that is associated with a popularity value that is less than a threshold value; and
remove the identified sub-execution path from the feature tree.

19. The system of claim 17, wherein the one or more programming instructions that, when executed, cause the computing device to cluster the plurality of users into a plurality of interest groups comprise one or more programming instructions that, when executed, cause the computing device to:
for each user, determine a rating that the user assigned to one or more sub-execution paths in the associated feature tree; and
cluster the users based on the ratings so that users who assigned similar ratings to sub-execution paths are included in the same interest group.

20. The system of claim 12, wherein the one or more programming instructions that, when executed, cause the computing device to predict one or more preferences for one or more users in the interest group comprise one or more programming instructions that, when executed, cause the computing device to:
identify a first execution path that was rated highly by a user in the interest group;
identify a second execution path that was rated poorly by the user in the interest group, wherein the first execution path and the second execution path share one or more common services and a common length;
identify a plurality of quality of service attributes associated with the first execution path and the second execution path; and
for each identified quality of service attribute:
determine a first value that is associated with the first execution path,
determine a second value that is associated with the second execution path, and
use the first value and the second value to determine a probability that the quality of service attribute is responsible for the poor rating of the second execution path.

21. The system of claim 20, wherein the computer-readable storage medium further comprises one or more programming instructions that, when executed, cause the computing device to:
identify one or more quality of service attributes having a probability that does not exceed a threshold value; and
update profiles of the users in the interest group to reflect a preference for the identified quality of service attributes.

22. The system of claim 20, wherein the computer-readable storage medium further comprises one or more programming instructions that, when executed, cause the computing device to recommend one or more subsequent workflows to at least one of the users in the interest group such that the recommended workflows each reflect the preference.
